(19) United States
(12) Patent Application Publication
(10) Pub. No.: US 2009/0020897 A1
(43) Pub. Date: Jan. 22, 2009

(54) PROCESS FOR THE INCORPORATION OF NANOPHOSPHORS INTO MICRO-OPTICAL STRUCTURES

(76) Inventors: Holger Winkler, Darmstadt (DE); Thomas Juestel, Witten (DE); Joachim Opitz, Aachen (DE); Helmut Bechtel, Roelgen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/280,704

(22) PCT Filed: Jan. 27, 2007
(86) PCT No.: PCT/EP2007/000720

§ 371 Date: Aug. 26, 2008

(30) Foreign Application Priority Data
Feb. 27, 2006 (DE) 10 2006 008 879.4

(51) Int. Cl. B29D 11/00; C01B 21/00; C01B 33/20

(52) U.S. Cl. 264/1.22; 264/2.6; 264/1.21; 423/351; 423/326

(57) ABSTRACT

The invention relates to a process for the incorporation of nanophosphors (phosphors) into micro-optical structures, and to corresponding illuminants. In this impregnation process, a micro-optical system comprising inverse opal powders is filled with a dispersion of a nanophosphor.

The invention relates to a process for the incorporation of nanophosphors into micro-optical structures, and to corresponding illuminants.

In white LEDs which are customary today, the primary of light source used is blue-emitting InGaN semiconductors which have an emission band between 400 and 480 nm, depending on the composition of the semiconductor mixed crystal.

The emission of white light is achieved by a coating with the phosphor (Y,Gd)₃(Al,Ga)₅O₁₂:Ce (YAG:Ce), which strongly absorbs blue radiation and, depending on the composition, emits in a broad band at 560-580 nm. The result is a white LED light source which, at a very high colour temperature of 5000 K, achieves a high colour reproduction index of CRI≈80 and a light yield of up to 30 Im/W (M. Born, T. Jüstel, Umweltfreundliche Lichtquellen [Environmentally Friendly Light Sources], Physik Journal 2 (2003) 43).

However, the continued spread of LEDs in general and automobile lighting requires the solution to some technical problems.

Firstly, today's white LEDs still exhibit an inadequate light yield. This requires on the one hand further development of the semiconductor and on the other hand optimisation of the phosphors with respect to their quantum yield and emission spectrum. Secondly, the colour reproduction index of white LEDs, in particular at low colour temperatures, is still too low (CRI<70) to find broad application in general lighting. The current development of red-emitting line phosphors represents the only possibility for solving the said problems.

Micro-optical structures are used to influence the optical properties of systems installed in their interior.

For example, it is possible to enhance the excitation of phosphors in the interior of inverse opals by resonance phenomena.

For industrial implementation of such systems, however, it is vital that charging of relatively large amounts of micro-optical systems with phosphors (or colorants) in a manner which is simple to carry out is facilitated.

Surprisingly, a suitable impregnation process has now been found in which a micro-optical system comprising inverse opals is filled with a dispersion of a nanophosphor or precursors of nanophosphors by diffusion.

The present invention therefore relates to a process for the preparation of a photonic material having regularly arranged cavities containing at least one colorant, where
a) opal template spheres are regularly arranged,
b) the sphere interspaces are filled with one or more wall material precursors,
c) the wall material is formed, and the opal template spheres are removed,
d) the colorant is introduced into the cavities, where dissolved colorant precursors are introduced into the cavities of the inverse opal by means of solution impregnation utilising pore diffusion,
e) the solvent is removed,
f) the precursors are converted into the colorant in a subsequent step.

For the purposes of the present invention, photonic materials comprising arrangements of cavities having an essentially monodisperse size distribution are materials which have three-dimensional photonic structures. Three-dimensional photonic structures are generally taken to mean systems which have regular, three-dimensional modulation of the dielectric constants (and thus also of the refractive index). If the periodic modulation length corresponds approximately to the wavelength of (visible) light, the structure interacts with the light in the manner of a three-dimensional diffraction grating, which is evident from angle-dependent colour phenomena.

The inverse structure to the opal structure (=arrangement of cavities having an essentially monodisperse size distribution) is thought to form through regular spherical hollow volumes being arranged in closest packing in a solid material. An advantage of inverse structures of this type over normal structures is the formation of photonic band gaps with dielectric constant contrasts which are already much lower (K. Busch et al. Phys. Rev. Letters E, 198, 50, 3896).

Photonic materials which have cavities must consequently have a solid wall. Suitable in accordance with the invention are wall materials which have dielectric properties and as such essentially have a non-absorbent action for the wavelength of an absorption band of the respective colorant and are essentially transparent for the wavelength of a colorant emission which can be stimulated by the absorption wavelength. The wall material of the photonic material should as such allow at least 95% of the radiation of the colorant absorption band wavelength to pass through.

The matrix here essentially consists of a radiation-stable organic polymer, which is preferably crosslinked, for example an epoxy resin. In another variant of the invention, the matrix essentially consists of an inorganic material, preferably a metal chalcogenide or metal pnictide, around the cavities, where mention may be made, in particular, of silicon dioxide, aluminium oxide, zirconium oxide, iron oxides, titanium dioxide, cerium dioxide, gallium nitride, boron nitride, aluminium nitride, silicon nitride and phosphorus nitride, or mixtures thereof. It is particularly preferred in accordance with the invention for the wall of the photonic material essentially to consist of an oxide or mixed oxide of silicon, titanium, zirconium and/or aluminium, preferably of silicon dioxide.

Three-dimensional inverse structures, i.e. micro-optical systems to be employed in accordance with the invention having regular arrangements of cavities, can be produced, for example, by a template synthesis:

The primary building blocks used to construct inverse opals are uniform colloidal spheres (point 1 in FIG. 1). Besides further characteristics, the spheres must obey the narrowest possible size distribution (5% size deviation is tolerable). Preference is given in accordance with the invention to monodisperse PMMA spheres having a diameter in the submicron range produced by aqueous emulsion polymerisation. In the second step, the uniform colloidal spheres, after isolation and centrifugation or sedimentation, are arranged in a three-dimensional regular opal structure (point 2 in FIG. 1). This template structure corresponds to closest spherical packing, i.e. 74% of the space is filled with spheres and 26% of the space is empty (interspaces or hollow volumes). It can then be solidified by conditioning. In the next working step (point 3 in FIG. 1), the cavities of the template are filled with a substance which forms the walls of the later inverse opal. The substance can be, for example, a solution of a precursor (preferably tetraethoxysilane). The precursor is then solidified by calcination, and the template spheres are likewise removed by calcination (point 4 in FIG. 1). This is possible if the spheres are polymers and the precursor is capable, for example, of carrying out a sol-gel reaction (transformation of, for example, silicic esters into SiO₂). After complete calcination, a replica of the template, the so-called inverse opal, is obtained.

Many such processes, which can be used for the production of cavity structures for use in accordance with the present invention, are known in the literature (for example S. G. Romanov et al., Handbook of Nanostructured Materials and Nanotechnology, Vol. 4, 2000, 231 ff.; V. Colvin et al. Adv. Mater. 2001, 13, 180; De La Rue et al. Synth. Metals, 2001, 116, 469; M. Martinelli et al. Optical Mater. 2001, 17, 11; A. Stein et al. Science, 1998, 281, 538). Core/shell particles whose shell forms a matrix and whose core is essentially solid and has an essentially monodisperse size distribution are described in DE-A-10145450. The use of core/shell particles whose shell forms a matrix and whose core is essentially solid and has an essentially monodisperse size distribution as templates for the production of inverse opal structures and a process for the production of inverse opal-like structures using such core/shell particles are described in International Patent Application WO 2004/031102. The mouldings described having homogeneous, regularly arranged cavities preferably have walls of metal oxides or of elastomers. The mouldings described are consequently either hard and brittle or exhibit an elastomeric character.

The removal of the regularly arranged template cores can be carried out by various methods. If the cores consist of suitable inorganic materials, these can be removed by etching. Silicon dioxide cores, for example, can preferably be removed using HF, in particular dilute HF solution.

If the cores in the core/shell particles are built up from a material which can be degraded by means of UV radiation, preferably a UV-degradable organic polymer, the cores are removed by UV irradiation. In this procedure too, it may in turn be preferred for crosslinking of the shell to be carried out before or after removal of the cores. Suitable core materials are then, in particular, poly(tert-butyl methacrylate), poly(methyl methacrylate), poly(n-butyl methacrylate) or copolymers which contain one of these polymers.

It may furthermore be particularly preferred for the degradable core to be thermally degradable and to consist of polymers which are either thermally depolymerisable, i.e. decompose into their monomers on exposure to heat, or for the core to consist of polymers which on degradation decompose into low-molecular-weight constituents which are different from the monomers. Suitable polymers are given, for example, in the table “Thermal Degradation of Polymers” in Brandrup, J. (Ed.): Polymer Handbook. Chichester Wiley 1966, pp. V-6-V-10, where all polymers which give volatile degradation products are suitable. The contents of this table are expressly incorporated into the disclosure content of the present application.

Preference is given here to the use of poly(styrene) and derivatives, such as poly(α-methylstyrene) or poly(styrene) derivatives which carry substituents on the aromatic ring, such as, in particular, partially or perfluorinated derivatives, poly(acrylate) and poly(methacrylate) derivatives and esters thereof, particularly preferably poly(methyl methacrylate) or poly(cyclohexyl methacrylate), or copolymers of these polymers with other degradable polymers, such as, preferably, styrene-ethyl acrylate copolymers or methyl methacrylate-ethyl acrylate copolymers, and polyolefins, polyolefin oxides, polyethylene terephthalate, polyformaldehyde, polyamides, polyvinyl acetate, polyvinyl chloride or polyvinyl alcohol.

Regarding the description of the resultant mouldings and the processes for the production of mouldings, reference is made to WO 2004/031102, the disclosure content of which is expressly incorporated into the present application.

It is particularly preferred in accordance with the invention for the average diameter of the cavities in the photonic material to be in the range about 100-600 nm, preferably in the range 150-350 nm.

The mouldings of the inverse opal are either produced directly in powder form in the corresponding processes or can be comminuted by grinding. The resultant particles can then be processed further in the sense according to the invention.

As already mentioned, the structure of the inverse opal has a porosity of 74%, enabling it to be charged easily with further substances. The pore system of the inverse opal consists of spherical cavities (corresponding to the spheres of the template), which are linked to one another in a three-dimensional manner by a channel system (corresponds to the previous points of contact of the template spheres with one another). Phosphors (or colorants) or phosphor precursors which are able to pass through the linking channels (FIG. 2) can then be introduced into the interior of the opal structure.

The colorants or colorant precursors are introduced into the pore systems of the inverse opal powder by solution impregnation utilising capillary effects.

The degree of charging or filling of the cavities with colorants or colorant precursors is an important criterion here. It is preferred in accordance with the invention to repeat the charging steps a number of times (see FIG. 4). It has been found here that excessively high degrees of filling of the cavities influence the photonic properties. It is therefore preferred in accordance with the invention for the cavities of the photonic material to be filled to the extent of at least 1% by vol. and at most 50% by vol. with the at least one colorant, where the cavities are particularly preferably filled to the extent of at least 5% by vol. and at most 30% by vol. with the at least one colorant.

For colorants which are preferably to be employed in accordance with the invention and which have a density of about 4 g/cm³, the at least one colorant therefore makes up 5 to 75% by weight of the photonic material, where the at least one colorant preferably makes up 25 to 66% by weight of the photonic material.

In a preferred process variant, the colorant can, after removal of the opal template spheres, be introduced into the cavities. This is carried out, for example, by infiltrating the photonic material having regularly arranged cavities with a colorant dispersion or a dispersion of colorant precursors and subsequently removing the dispersion medium.

The nanoscale colorants can be infiltrated into the inverse opals described above if the particle size of the colorant particles is smaller than the diameter of the linking channels between the cavities of the inverse opals. In a preferred embodiment of the present invention, the nanoscale phosphor particles are, before the infiltration, in the form of a substantially agglomerate-free dispersion in a liquid, preferably water or another volatile solvent (for example ethanol) (see FIG. 3). This process variant is preferably used in the case of phosphors which can be prepared exclusively by solid-state reactions of the starting materials.

Furthermore, it is sensible to ensure complete filling of the cavities of the inverse opal with the suspension liquid in the infiltration method. This is achieved, for example, using the following method:

The colorant dispersion is added to the inverse opal powder (preferably SiO₂), and the suspension is evacuated in order to remove the air included in the cavities of the inverse opal. The suspension is then aerated in order to fill the cavities completely with the nanophosphor suspension. The infiltrated particles are separated off from the excess nanophosphor suspension via a membrane filter, washed and dried. This is followed by calcination.

In a second variant of the process according to the invention (“precursor impregnation”, see FIG. 2), one or more colorant precursors dissolved in water or an alcohol are added to the inverse opal powder, and the suspension is evacuated and stirred for a number of hours in order to remove the air included in the cavities of the inverse opal. The suspension is then aerated in order to fill the cavities completely with the precursor suspension. The infiltrated inverse opal particles are separated off, washed and dried. The precursor particles in the interior of the inverse opal are converted into phosphor particles by subsequent calcination.

The last-mentioned process variant has the advantage that aqueous or alcoholic precursor solutions consisting of dissolved molecules or salts (such as, for example, a mixture of Y(NO₃)₃ or Eu(NO₃)₃) are able to penetrate into the pore system of the inverse opal more easily than nanophosphor particles or colorant dispersions (such as, for example, aqueous (Y_{0.93}Eu³⁺_{0.07})VO₄ dispersions, see FIG. 3), since nanophosphor particles cannot be produced as small as desired in order to prevent blockage of the linking channels between the cavities in the opal, since the efficiency decreases rapidly with decreasing particle size (<10 nm) in the case of some nanophosphors.

In a further variant of the process according to the invention for the preparation of a photonic material, at least one colorant or colorant precursor is introduced into the opal template spheres before step a). On decomposition of the precursor cores, the colorant particles then remain in the resultant cavities. In this process variant, the size of the colorant particles is limited only by the size of the opal template spheres.

It is preferred in accordance with the invention for one or more precursors of colorants and/or nanoparticulate colorants additionally to be introduced into the sphere interspaces in addition to the wall material precursors in step b) of the process for the preparation of a photonic material.

It is furthermore preferred for step c) of the process according to the invention to be a calcination, preferably above 200° C., particularly preferably above 400° C.

In addition, it may be particularly preferred for a reactive gas also to be added in step f) of the process according to the invention in addition to the calcination, preferably above 200° C., particularly preferably above 400° C. Reactive gases that can be employed, depending on the phosphor particles used, are H₂S, H₂/N₂, O₂, CO, etc. The choice of suitable gas here is dependent on the type and chemical composition of the phosphor and inverse opal, which is known and familiar to the person skilled in the art.

It is also preferred in accordance with the invention for the solvent removal in step e) of the process to be carried out under reduced pressure and/or at elevated temperature.

The colorant or phosphor according to the invention is preferably nanoscale phosphor particles. The colorants here are generally composed in chemical terms of a host material and one or more dopants.

The host material can preferably comprise compounds from the group of the sulfides, selenides, sulfoselenides, oxysulfides, borates, aluminates, gallates, silicates, germanates, phosphates, halophosphates, oxides, arsenates, vanadates, niobates, tantalates, sulfates, tungstates, molybdates, alkali metal halogenates, nitrides, nitridosilicates, oxynitridosilicates and other halides. The host materials here are preferably alkali metal, alkaline earth metal or rare-earth compounds.

The colorant here is preferably in nanoparticulate form. Preferred particles here exhibit a mean particle size of less than 50 nm, determined as the hydraulic diameter by means of dynamic light scattering, it being particularly preferred for the mean particle diameter to be less than 25 nm.

In a variant of the invention, the light from blue light sources is to be supplemented with red components. In this case, the colorant is, in a preferred embodiment of the present invention, an emitter for radiation in the range from 550 to 700 nm. The preferred dopants here include, in particular, rare-earth compounds doped with europium, samarium, terbium or praseodymium, preferably with triply positively charged europium ions.

According to one aspect of the present invention, the dopant used is furthermore one or more elements from a group comprising elements from main groups 1a, 2a or Al, Cr, TI, Mn, Ag, Cu, As, Nb, Ni, Ti, In, Sb, Ga, Si, Pb, Bi, Zn, Co and/or elements of the so-called rare-earth metals.

A dopant pair matched to one another, for example cerium and terbium, can preferably be used, where appropriate per desired fluorescence colour, with good energy transfer, where one acts as energy absorber, in particular as UV light absorber, and the other acts as fluorescent light emitter.

In particular, the material selected for the doped nanoparticles can be the following compounds, where in the following notation the host compound is indicated to the left of the colon and one or more doping elements are indicated to the right of the colon. If chemical elements are separated from one another by commas and are bracketed, their use is optional. Depending on the desired fluorescence property of the nanoparticles, one or more of the compounds available for selection can be used:

BaAl₂O₄:Eu²⁺, BaAl₂S₄:Eu²⁺, BaB₈O₁₋₃:Eu²⁺, BaF₂, BaFBr:Eu²⁺, BaFCl:Eu²⁺, BaFCl:Eu²⁺, Pb²⁺, BaGa₂S₄:Ce³⁺, BaGa₂S₄:Eu²⁺, Ba₂Li₂Si₂ O₇:Eu²⁺, Ba₂Li₂Si₂ O₇:Sn²⁺, Ba₂Li₂Si₂ O₇:Sn²⁺, Mn²⁺, BaMgAl,₀O₁₇:Ce³⁺, BaMgAl₁₀O₁₇:Eu²⁺, BaMgAl₁₀O₁₇:Eu²⁺, Mn²⁺, Ba₂Mg₃F₁₀:Eu²⁺, BaMg₃F₈:Eu²⁺, Mn²⁺, Ba₂MgSi₂O₇:Eu²⁺, BaMg₂Si₂O₇:Eu²⁺, Ba₅(PO₄)₃Cl:Eu²⁺, Ba₅(PO₄)₃Cl:U, Ba₃(PO₄)₂:Eu²⁺, BaS:Au, K, BaSO₄:Ce³⁺, BaSO₄:Eu²⁺, Ba₂SiO₄:Ce³⁺, Li⁺, Mn²⁺, Ba₅SiO₄Cl₆:Eu²⁺, BaSi₂O₅:Eu²⁺, Ba₂SiO₄: Eu²⁺, BaSi₂O₅:Pb²⁺, BaₓSri₁₋ₓF₂:Eu²⁺, BaSrMgSi₂O₇:Eu²⁺, BaTiP₂O₇, (Ba, Ti)₂P₂O₇:Ti, Ba₃WO₆:U, BaY₂F₈ Er³⁺, Yb+, Be₂SiO₄:Mn²⁺, Bi₄Ge₃O₁₂, CaAl₂O₄:Ce³⁺, CaLa₄O₇:Ce³⁺, CaAl₂O₄:Eu²⁺, CaAl₂O₄:Mn²⁺, CaAl₄O₇:Pb²⁺, Mn²⁺, CaAl₂O₄:Tb³⁺, Ca₃Al₂Si₃O₁₂:Ce³⁺, Ca₃Al₂Si₃Oi₂:Ce³⁺, Ca₃Al₂Si₃O,₂:Eu²⁺, Ca₂B₅O₉Br:Eu²⁺, Ca₂B₅O₉Cl:Eu²⁺, Ca₂B₅O₉Cl:Pb²⁺, CaB₂O₄:Mn²⁺, Ca₂B₂O₅:Mn²⁺, CaB₂O₄:Pb²⁺, CaB₂P₂O₉:Eu²⁺, Ca₅B₂SiO₁₀:Eu³⁺, Ca_{0.5}Ba_{0.5}Al₁₂O₁₉:Ce³⁺, Mn²⁺, Ca₂Ba₃(PO4)₃Cl:Eu²⁺, CaBr₂:Eu²⁺ in SiO₂, CaCl₂:Eu²⁺ in SiO₂, CaCl₂:Eu²⁺, Mn²⁺ in SiO₂, CaF₂:Ce³⁺, CaF₂:Ce³⁺, Mn²⁺, CaF₂:Ce³⁺, Tb³⁺, CaF₂:Eu²⁺, CaF₂:Mn²⁺, CaF₂:U, CaGa₂O₄:Mn²⁺, CaGa₄O₇:Mn²⁺, CaGa₂S₄:Ce³⁺, CaGa₂S₄:Eu²⁺, CaGa₂S₄:Mn²⁺, CaGa₂S₄:Pb²⁺, CaGeO₃:Mn²⁺, CaI₂:Eu²⁺ in SiO₂, CaI₂:Eu²⁺, Mn²⁺ in SiO₂, CaLaBO₄:Eu³⁺, CaLaB₃O₇:Ce³⁺, Mn²⁺, Ca₂La₂BO_{6.5}:Pb²⁺, Ca₂MgSi₂O₇, Ca₂MgSi₂O₇:Ce³⁺, CaMgSi₂O₆:Eu²⁺, Ca₃MgSi₂O₈:Eu²⁺, Ca₂MgSi₂O₇:Eu²⁺, CaMgSi₂O₆:Eu²⁺, Mn²⁺, Ca₂MgSi₂O₇:Eu²⁺, Mn²⁺, CaMoO₄, CaMoO₄:Eu³⁺, CaO:Bi³⁺, CaO:Cd²⁺, CaO:Cu⁺, CaO:Eu³⁺, CaO:Eu³⁺, Na⁺, CaO:Mn²⁺, CaO:Pb²⁺, CaO:Sb³⁺, CaO:Sm³⁺, CaO:Tb³⁺, CaO:Tl, CaO.Zn²⁺, Ca₂P₂O₇:Ce³⁺, α-Ca₃(PO₄)₂:Ce³⁺, β-Ca₃(PO₄)₂:Ce³⁺, Ca₅(PO₄)₃Cl:Eu²⁺, Ca₅(PO₄)₃Cl:Mn²⁺, Ca₅(PO₄)₃Cl:Sb³⁺, Ca₅(PO₄)₃Cl:Sn²⁺, β-Ca₃(PO₄)₂:Eu²⁺, Mn²⁺, Ca₅(PO₄)₃F:Mn²⁺, Caₛ(PO₄)₃F:Sb³⁺, Caₛ(PO₄)₃F:Sn²⁺, α-Ca₃(PO₄)₂:Eu²⁺, β-Ca₃(PO₄)₂:Eu²⁺, Ca₂P₂O₇:Eu²⁺, Ca₂P₂O₇:Eu²⁺, Mn²⁺, CaP₂O₆:Mn²⁺, α-Ca₃(PO₄)₂:Pb²⁺, α-Ca₃(PO₄)₂:Sn²⁺, β-Ca₃(PO₄)₂:Sn²⁺, β-Ca₂P₂O₇:Sn, Mn, α-Ca₃(PO₄)₂:Tr, CaS:Bi³⁺, CaS:Bi³⁺, Na, CaS:Ce³⁺, CaS:Eu²⁺, CaS:Cu⁺, Na⁺, CaS:La³⁺, CaS:Mn²⁺, CaSO₄:Bi, CaSO₄:Ce³⁺, CaSO₄:Ce³⁺, Mn²⁺, CaSO₄:Eu²⁺, CaSO₄:Eu²⁺, Mn²⁺, CaSO₄:Pb²⁺, CaS:Pb²⁺, CaS:Pb²⁺, Cl, CaS:Pb²⁺, Mn²⁺, CaS:Pr³⁺, Pb²⁺, Cl, CaS:Sb³⁺, CaS:Sb³⁺, Na, CaS:Sm³⁺, CaS:Sn²⁺, CaS:Sn²⁺, F, CaS:Tb³⁺, CaS:Tb³⁺, Cl, CaS:Y³⁺, CaS:Yb²⁺, CaS:Yb²⁺, Cl, CaSiO₃:Ce³⁺, Ca₃SiO₄Cl₂:Eu²⁺, Ca₃SiO₄Cl₂:Pb²⁺, CaSiO₃:Eu²⁺, CaSiO₃:Mn²⁺, Pb, CaSiO₃:Pb²⁺, CaSiO₃:Pb²⁺, Mn²⁺, CaSiO₃:Ti⁴⁺, CaSr₂(PO₄)₂:Bi³⁺, β-(Ca,Sr)₃(PO₄)₂:Sn²+Mn²⁺, CaTi_{0.9}Al_{0.1}O₃:Bi³⁺, CaTiO₃:Eu³⁺, CaTiO₃:Pr³⁺, Ca₅(VO₄)₃Cl, CaWO₄, CaWO₄:Pb²⁺, CaWO₄:W, Ca₃WO₆:U, CaYAlO₄:Eu³⁺, CaYBO₄:Bi³⁺, CaYBO₄:Eu³⁺, CaYB_{0.8}O_{3.7}:Eu³⁺, CaY₂ZrO₆:Eu³⁺, (Ca,Zn,Mg)₃(PO₄)₂:Sn, CeF₃, (Ce,Mg)BaAl₁₁O₁₈:Ce, (Ce,Mg)SrAl₁₁O₁₈:Ce, CeMgAl₁₁O₁₉:Ce:Tb, Cd₂B₆O₁₁:Mn²⁺, CdS:Ag⁺, Cr, CdS:In, CdS:In, CdS:In, Te, CdS:Te, CdWO₄, CsF, CsI, CsI:Na⁺, CsI:Tl, (ErCl₃)_{0.25}(BaCl₂)_{0.75}, GaN:Zn, Gd₃Ga₅O₁₂:Cr³⁺, Gd₃Ga₅O₁₂:Cr, Ce, GdNbO₄:Bi³⁺, Gd₂O₂S:Eu³⁺, Gd₂O₂Pr³⁺, Gd₂O₂S:Pr,Ce,F, Gd₂O₂S:Tb³⁺, Gd₂SiO₅:Ce³⁺, KAl₁₁O₁₇:Tl⁺, KGa₁₁O₁₇:Mn²⁺, K₂La₂Ti₃O₁₀:Eu, KMgF₃:Eu²⁺, KMgF₃:Mn²⁺, K₂SiF₆:Mn⁴⁺, LaAl₃B₄O₁₂:Eu³⁺, LaAlB₂O₆:Eu³⁺, LaAlO₃:Eu³⁺, LaAlO₃:Sm³⁺, LaAsO₄:Eu³⁺, LaBr₃:Ce³⁺, LaBO₃:Eu³⁺, (La,Ce,Tb)PO₄:Ce:Tb, LaCl₃:Ce³⁺, La₂O₃:Bi³⁺, LaOBr:Tb³⁺, LaOBr:Tm³⁺, LaOCl:Bi³⁺, LaOCl:Eu³⁺, LaOF:Eu³⁺, La₂O₃:Eu³⁺, La₂O₃:Pr³⁺, La₂O₂S:Tb³⁺, LaPO₄:Ce³⁺, LaPO₄:Eu³⁺, LaSiO₃Cl:Ce³⁺, LaSiO₃Cl:Ce³⁺, Tb³⁺, LaVO₄:Eu³⁺, La₂W₃O₁₂:Eu³⁺, LiAlF₄:Mn²⁺, LiAl₅O₈:Fe³⁺, LiAlO₂:Fe³⁺, LiAlO₂:Mn²⁺, LiAl₅O₈:Mn²⁺, Li₂CaP₂O₇:Ce³⁺, Mn²⁺, LiCeBa₄Si₄O₁₄:Mn²⁺, LiCeSrBa₃Si₄O₁₄:Mn²⁺, LiInO₂:Eu³⁺, LiInO₂:Sm³⁺, LiLaO₂:Eu³⁺, LuAlO₃:Ce³⁺, (Lu,Gd)₂SiO₅:Ce³⁺, Lu₂SiO₅:Ce³⁺, Lu₂Si₂O₇:Ce³⁺, LuTaO₄:Nb⁵⁺, Lu₁₋ₓYₓAlO₃:Ce³⁺, MgAl₂O₄:Mn²⁺, MgSrAl₁₀O₁₇:Ce, MgB₂O₄:Mn²⁺, MgBa₂(PO₄)₂:Sn²⁺, MgBa₂(PO₄)₂:U, MgBaP₂O₇:Eu²⁺, MgBaP₂O₇:Eu²⁺, Mn²⁺, MgBa₃Si₂O₈:Eu²⁺, MgBa(SO₄)₂:Eu²⁺, Mg₃Ca₃(PO₄)₄:Eu²⁺, MgCaP₂O₇:Mn²⁺, Mg₂Ca(SO₄)₃:Eu²⁺, Mg₂Ca(SO₄)₃:Eu²⁺, Mn², MgCeAlₙO₁₉:Tb³⁺, Mg₄(F)GeO₆:Mn²⁺, Mg₄(F)(Ge,Sn)O₆:Mn²⁺, MgF₂:Mn²⁺, MgGa₂O₄:Mn²⁺, Mg₈Ge₂O₁₁F₂:Mn⁴⁺, MgS:Eu²⁺, MgSiO₃:Mn²⁺, Mg₂SiO₄:Mn²⁺, Mg₃SiO₃F₄:Ti⁴⁺, MgSO₄:Eu²⁺, MgSO₄:Pb²⁺, MgSrBa₂Si₂O₇:Eu²⁺, MgSrP₂O₇:Eu²⁺, MgSr₅(PO₄)₄:Sn²⁺, MgSr₃Si₂O₈:Eu²⁺, Mn²⁺, Mg₂Sr(SO₄)₃:Eu²⁺, Mg₂TiO₄:Mn⁴⁺, MgWO₄, MgYBO₄:Eu³⁺, Na₃Ce(PO₄)₂:Tb³⁺, NaI:Tl, Na_{1.23}K_{0.42}Eu_{0.12}TiSi₄O₁₁:Eu³⁺, Na_{1.23}K_{0.42}Eu_{0.12}TiSi₅O₁₃.xH₂O:Eu³⁺, Na_{1.29}K_{0.46}Er_{0.08}TiSi₄O₁₁:Eu³⁺, Na₂Mg₃Al₂Si₂O₁₀:Tb, Na(Mg₂₋ₓMnₓ)LiSi₄O₁₀F₂:Mn, NaYF₄:Er³⁺, Yb³⁺, NaYO₂:Eu³⁺, P46 (70%)+P47 (30%), SrAl₁₂O₁₉:Ce³⁺, Mn²⁺, SrAl₂O₄:Eu²⁺, SrAl₄O₇:Eu³⁺, SrAl₁₂O₁₉:Eu²⁺, SrAl₂S₄:Eu²⁺, Sr₂B₅O₉Cl:Eu²⁺, SrB₄O₇:Eu²⁺ (F,Cl,Br), SrB₄O₇:Pb²⁺, SrB₄O₇:Pb²⁺, Mn²⁺, SrB₈O₁₃:Sm²⁺, SrₓBa_{y}Cl_{z}Al₂O_{4-z/2}:Mn²⁺, Ce³⁺, SrBaSiO₄:Eu²⁺, Sr(Cl,Br,I)₂:Eu²⁺ in SiO₂, SrCl₂:Eu²⁺ in SiO₂, Sr₅Cl(PO₄)₃:Eu, Sr_{w}FₓB₄O_{6.5}:Eu²⁺, Sr_{w}FₓB_{y}O_{z}:Eu²⁺, Sm²⁺, SrF₂:Eu²⁺, SrGa₁₂O₁₉:Mn²⁺, SrGa₂S₄:Ce³⁺, SrGa₂S₄:Eu²⁺, SrGa₂S₄:Pb²⁺, SrIn₂O₄:Pr³⁺, Al³⁺, (Sr,Mg)₃(PO₄)₂:Sn, SrMgSi₂O₆:Eu²⁺, Sr₂MgSi₂O₇:Eu²⁺, Sr₃MgSi₂O₈:Eu²⁺, SrMoO₄:U, SrO.3B₂O₃:Eu²⁺, Cl, β-SrO.3B₂O₃:Pb²⁺, β-SrO.3B₂O₃:Pb²⁺, Mn²⁺, α-SrO.3B₂O₃:Sm²⁺, Sr₆P₅BO₂₀:Eu, Sr₅(PO₄)₃Cl:Eu²⁺, Sr₅(PO₄)₃Cl:Eu²⁺, Pr³⁺, Sr₅(PO₄)₃Cl:Mn²⁺, Sr₅(PO₄)₃Cl:Sb³⁺, Sr₂P₂O₇:Eu²⁺, β-Sr₃(PO₄)₂:Eu²⁺, Sr₅(PO₄)₃F:Mn²⁺, Sr₅(PO₄)₃F:Sb³⁺, Sr₅(PO₄)₃F:Sb³⁺, Mn , Sr₅(PO₄)₃F:Sn²⁺, Sr₂P₂O₇:Sn²⁺, β-Sr₃(PO₄)₂:Sn²⁺, β-Sr₃(PO₄)₂:Sn²⁺, Mn²⁺(Al), SrS:Ce³⁺, SrS:Eu²⁺, SrS:Mn²⁺, SrS:Cu⁺, Na, SrSO₄:Bi, SrSO₄:Ce³⁺, SrSO₄:Eu²⁺, SrSO₄:Eu²⁺, Mn²⁺, Sr₅Si₄O₁₀Cl₆:Eu²⁺, Sr₂SiO₄:Eu²⁺, SrTiO₃:Pr³⁺, SrTiO₃:Pr³⁺, Al³⁺, Sr₃WO₆:U, SrY₂O₃:Eu³⁺, ThO₂:Eu³⁺, ThO₂:Pr³⁺, ThO₂:Tb³⁺, YAl₃B₄O₁₂:Bi³⁺, YAl₃B₄O₁₂:Ce³⁺, YAl₃B₄O₁₂:Ce³⁺, Mn, YAl₃B₄O₁₂:Ce³⁺, Tb³⁺, YAl₃B₄O₁₂:Eu³⁺, YAl₃B₄O₁₂:Eu³⁺, Cr³⁺, YAl₃B₄O₁₂:Th⁴⁺, Ce³⁺, Mn²⁺, YAlO₃:Ce³⁺, Y₃Al₅O₁₂:Ce³⁺, Y₃Al₅O₁₂:Cr³⁺, YAlO₃:Eu³⁺, Y₃Al₅O₁₂:Eu^{3r}, Y₄Al₂O₉:Eu³⁺, Y₃Al₅O₁₂:Mn⁴⁺, YAlO₃:Sm³⁺, YAlO₃:Tb³⁺, Y₃Al₅O₁₂:Tb³⁺, YAsO₄:Eu³⁺, YBO₃:Ce³⁺, YBO₃:Eu³⁺, YF₃:Er³⁺, Yb³⁺, YF₃:Mn²⁺, YF₃:Mn²⁺, Th⁴⁺, YF₃:Tm³⁺, Yb³⁺, (Y, Gd)BO₃:Eu, (Y, Gd)BO₃:Tb, (Y, Gd)₂O₃:Eu³⁺, Y_{1.34}Gd_{0.60}O₃(Eu, Pr), Y₂O₃:Bi³⁺, YOBr:Eu³⁺, Y₂O₃:Ce, Y₂O₃:Er³⁺, Y₂O₃:Eu³⁺(YOE), Y₂O₃:Ce³⁺, Tb³⁺, YOCl:Ce³⁺, YOCl:Eu³⁺, YOF:Eu³⁺, YOF:Tb³⁺, Y₂O₃:Ho³⁺, Y₂O₂S:Eu³⁺, Y₂O₂S:Pr³⁺, Y₂O₂S:Tb³⁺, Y₂O₃:Tb³⁺, YPO₄:Ce³⁺, YPO₄:Ce³⁺, Tb³⁺, YPO₄:Eu³⁺, YPO₄:Mn²⁺, Th⁴⁺, YPO₄:V⁵⁺, Y(P,V)O₄:Eu, Y₂SiO₅:Ce³⁺, YTaO₄, YTaO₄:Nb⁵⁺, YVO₄:Dy³⁺, YVO₄:Eu³⁺, ZnAl₂O₄:Mn²⁺, ZnB₂O₄:Mn²⁺, ZnBa₂S₃:Mn²⁺, (Zn,Be)₂SiO₄:Mn²⁺, Zn_{0.4}Cd_{0.6}S:Ag, Zn_{0.6}Cd_{0.4}S:Ag, (Zn,Cd)S:Ag, Cl, (Zn,Cd)S:Cu, ZnF₂:Mn²⁺, ZnGa₂O₄, ZnGa₂O₄:Mn²⁺, ZnGa₂S₄:Mn²⁺, Zn₂GeO₄:Mn²⁺, (Zn,Mg)F₂:Mn²⁺, ZnMg₂(PO₄)₂:Mn²⁺, (Zn,Mg)₃(PO₄)₂:Mn²⁺, ZnO:Al³⁺,Ga³⁺, ZnO:Bi³⁺, ZnO:Ga³⁺, ZnO:Ga, ZnO—CdO:Ga, ZnO:S, ZnO:Se, ZnO:Zn, ZnS:Ag⁺, Cl⁻, ZnS:Ag, Cu, Cl, ZnS:Ag,Ni, ZnS:Au, In, ZnS—CdS (25-75), ZnS—CdS (50-50), ZnS—CdS (75-25), ZnS—CdS:Ag, Br, Ni, ZnS—CdS:Ag⁺, Cl, ZnS—CdS:Cu, Br, ZnS—CdS:Cu, I, ZnS:Cl⁻, ZnS:Eu²⁺, ZnS:Cu, ZnS:Cu⁺, Al³⁺, ZnS:Cu⁺, Cl⁻, ZnS:Cu, Sn, ZnS:Eu²⁺, ZnS:Mn²⁺, ZnS:Mn, Cu, ZnS:Mn²⁺, Te²⁺, ZnS:P, ZnS:P³⁻, Cl⁻, ZnS:Pb²⁺, ZnS:Pb²⁺, Cl⁻, ZnS:Pb, Cu, Zn₃ (PO₄)₂:Mn²⁺, Zn₂SiO₄:Mn²⁺, Zn₂SiO₄:Mn²⁺, As⁵⁺, Zn₂SiO₄:Mn, Sb₂O₂, Zn₂SiO₄:Mn²⁺, P, Zn₂SiO₄:Ti⁴⁺, ZnS:Sn²⁺, ZnS:Sn, Ag, ZnS:Sn²⁺, Li⁺, ZnS:Te, Mn, ZnS—ZnTe:Mn²⁺, ZnSe:Cu⁺, Cl, ZnWO₄.

In accordance with a further selection list, the colorant is at least one compound M^{I}₂O₃:M^{II}, where M^{I}=Y, Sc, La, Gd, Lu and M^{II}=Eu, Pr, Ce, Nd, Tb, Dy, Ho, Er, Tm, Yb, or at least one compound M^{I}₂O₂S:M^{II} or at least one compound M^{III}S:M^{IV},M^{V},X, where M^{III}=Mg, Ca, Sr, Ba, Zn and M^{IV}=Eu, Pr, Ce, Mn, Nd, Tb, Dy, Ho, Er, Tm, Yb and M^{V}=Li, Na, K, Rb and X=F, Cl, Br, I, or at least one compound M^{III}M^{VI}₂S₄:M^{II}, where M^{VI}=Al, Ga, In, Y, Sc, La, Gd, Lu.

In accordance with a further selection list, the colorant is at least one compound Ln₂O₃:Eu, where Ln=Lu, Gd, Y, or at least one compound Ln (P, V) O₄:Eu, where Ln=Lu, Gd, Y, or at least one compound MeMoO₄:Eu, Na, where Me=Ba, Sr, Ca, or at least one compound MeWO₄:Eu, where Me=Ba, Sr, Ca.

Colorants of this type are either commercially available or can be obtained by preparation processes known from the literature. Preparation processes that are preferably to be used are described, in particular, in international patent applications WO 2002/20696 and WO 2004/096714, the corresponding disclosure content of which is expressly incorporated into the disclosure content of the present invention.

In accordance with this objective, the present invention furthermore relates to an illuminant containing at least one light source which is characterised in that it comprises at least one photonic material prepared by the process according to the invention.

In preferred embodiments of the present invention, the illuminant is a light-emitting diode (LED), an organic light-emitting diode (OLED), a polymeric light-emitting diode (PLED) or a fluorescent lamp.

For the application which is preferred in accordance with the invention in light-emitting diodes, it is advantageous for radiation selected from the wavelength range from 250 to 500 nm to be stored in the photonic material.

The blue to violet light-emitting diodes which are particularly suitable for the invention described here include semiconductor components based on GaN (InAlGaN). Suitable GaN semiconductor materials for the production of light-emitting components are described by the general formula InᵢGaⱼAlₖN, where 0≦i, 0≦j, 0≦k and l+j+k=1. These nitride semiconductor materials thus also include substances such as indium gallium nitride and GaN. These semiconductor materials may be doped with traces of further substances, for example in order to increase the intensity or to adjust the colour of the emitted light.

Light-emitting diodes based on zinc oxide are also preferred.

Laser diodes (LDs) are constructed in a similar manner from an arrangement of GaN layers. Processes for the production of LEDs and LDs are well known to the persons skilled in the art in this area.

Possible configurations in which a photonic structure can be coupled to a light-emitting diode or an arrangement of light-emitting diodes are LEDs mounted in a holding frame or on the surface.

Photonic structures of this type are useful in all configurations of illumination systems which contain a primary radiation source, including, but not restricted to, discharge lamps, fluorescent lamps, LEDs, LDs (laser diodes), OLEDs and X-ray tubes. The term “radiation” in this text encompasses radiation in the UV and IR regions and in the visible region of the electromagnetic spectrum. Of the OLEDS, the use of PLEDs—OLEDs comprising polymeric electroluminescent compounds—may be particularly preferred.

An example of a construction of an illumination system of this type is described in detail in EP 050174853 (Merck Patent GmbH), the disclosure content of which is expressly incorporated into the present application.

The following examples are intended to illustrate the present invention. However, they should in no way be regarded as limiting. All compounds or components which can be used in the compositions are either known and commercially available or can be synthesised by known methods.

### EXAMPLES

### Example 1

### Production of a Photonic Cavity Structure Having an SiO₂ Wall and Stop Band in the Blue-Green Region of the Spectrum

Firstly, monodisperse PMMA nanospheres are produced. This is carried out with the aid of emulsifier-free, aqueous emulsion polymerisation. To this end, a 2 l double-walled stirred vessel with anchor stirrer (300 rpm stirrer speed) and reflux condenser is charged with 1260 ml of deionised water and 236 ml of methyl methacrylate, and the mixture is held at a temperature of 80° C. A weak stream of nitrogen, which is able to escape via an overpressure valve on the reflux condenser, is passed into the mixture for 1 h, before 1.18 g of azodiisobutyramidine dihydrochloride as free-radical initiator are added. The formation of the latex particles is evident through the cloudiness which immediately sets in. The polymerisation reaction is monitored thermally, with a slight increase in the temperature due to the reaction enthalpy being observed. After 2 hours, the temperature has stabilised at 80° C. again, indicating the end of the reaction. After cooling, the mixture is filtered through glass wool. Investigation of the dried dispersion using the SEM shows uniform spherical particles having a mean diameter of 317 nm.

These spheres are used as template for the production of the photonic structure. To this end, 10 g of dried PMMA spheres are suspended in deionised water and filtered through a Buchner funnel with suction.

Variant: alternatively, the dispersion resulting from the emulsion polymerisation is spun or centrifuged directly in order to allow the particles to settle in an ordered manner, the supernatant liquid is removed, and the residue is processed further as described below.

Further variant: alternatively, the dispersion resulting from the emulsion polymerisation or the sphere sediment in the dispersion can also be evaporated slowly. Further processing as described below.

The filter cake is wetted with 10 ml of a precursor solution consisting of 3 ml of ethanol, 4 ml of tetraethoxysilane, 0.7 ml of conc. HCl in 2 ml of deionised water while maintaining the suction vacuum. After the suction vacuum has been switched off, the filter cake is dried for 1 h and then calcined in a corundum container in a tubular furnace in air. The calcination is carried out in accordance with the following temperature gradients:
a) from RT to a temperature of 100° C. in 2 h, hold at 100° C. for 2 h
b) from 100° C. to a temperature of 350° C. in 4 h, hold at 350° C. for 2 h
c) from 350° C. to a temperature of 550° C. in 3 h
d) the material is treated at 550° C. for a further 14 days, subsequently
e) cooled from 550° C. to RT at 10° C./min (from 550° C. to RT in 1 h).

The resulting inverse opal powder has a mean pore diameter of about 275 nm (cf. FIG. 1). The powder particles of the inverse opal have an irregular shape with a spherical equivalent diameter of 100 to 300 μm. The cavities have a diameter of about 300 nm and are linked to one another by apertures with a size of about 60 nm.

### Example 2

### Impregnation of an Alcoholic Solution of Molecular Phosphor Precursors into the Pores of the Inverse Opal and Conversion of the Precursors in the Interior of the Opal into the Phosphor

5 g of tris(tetramethylheptandionato)yttrium Y(C₁₁H₁₉O₂)₃ and tris(tetramethylheptanedionato)europium Eu(C₁₁H₁₉O₂)₃ in a weight ratio of 23:1 are dissolved in 50 ml of ethanol and injected into a container containing 0.5 g of dried inverse SiO₂ powder in a static vacuum (1×10⁻³ mbar). This mixture is stirred for 8 h in the maintained static vacuum. The mixture is then removed and filtered, and the filter cake is dried in a drying cabinet. Finally, the filter cake is calcined at 600° C., giving a whitish, fine powder which consists of Y₂O₃:Eu particles embedded in the inverse opal.

### Example 3

### Impregnation of an Aqueous Solution of Molecular Phosphor Precursors into the Pores of the Inverse Opal and Conversion of the Precursors in the Interior of the Opal into the Phosphor

0.01 mol of Y(NO₃)₃×6 H₂O and 0.0004 mol of Eu(NO₃)₃ are dissolved in 70 ml of water and injected into a container containing 0.5 g of dried inverse SiO₂ powder in a static vacuum. This mixture is stirred for 8 h in vacuo. The mixture is then removed and filtered, and the filter cake is dried in a drying cabinet. The filter cake is subsequently calcined at 600° C., giving a whitish, fine powder which consists of Y₂O₃:Eu particles embedded in the inverse opal.

### Example 4

### Infiltration of Nanophosphor Particles into the Pores of the Inverse Opal by Dispersion Diffusion

The phosphor dispersion is a 1% by weight aqueous dispersion of nanoparticles (Y_{0.93}Eu³⁺_{0.07}) VO₄ with a size of 10 nm, which is marketed as a 10% by weight aqueous dispersion by Nanosolutions GmbH under the name REN-X rot.

100 mg of inverse opal powder are heated at a temperature of 200° C. for one day in an oil vane-type rotary pump vacuum (1×10⁻³ mbar). This operation ensures that adsorbate located in the pores of the opal powder is removed. After cooling to room temperature, 10 ml of a 1% by weight aqueous phosphor dispersion are injected into the static vacuum in which the inverse opal powder is located, blanketing the inverse opal powder. Diffusion of the phosphor particles into the pores occurs here, driven by capillary forces. The mixture is left to stand overnight, during which the static vacuum dissipates until atmospheric pressure prevails over the system. The system is subsequently evacuated 5 times for 15 min each time in order to remove gas bubbles that have penetrated into the pores and to move further phosphor particles into the pores for diffusion. The diffusion can be enhanced by cavitation forces initiated by careful stirring during the aeration phases.

The supernatant dispersion is then decanted off, and the powder is washed a number of times with water, dried in a drying cabinet and subsequently heated at 600° C. for 3 h in a corundum dish in an oven and calcined at this temperature for 3 h before being cooled to room temperature.

### Example 5

### Impregnation of an Aqueous Solution of Molecular Phosphor Precursors (Complexes) into the Pores of the Inverse Opal and Thermal Conversion of the Precursors in the Interior of the Opal into the Phosphor

0.6 mmol of La(NO₃)₃ and 0.4 mmol of Eu(NO₃)₃ and 2 mmol of citric acid are dissolved in 10 ml of H₂O. 1.5 mmol of W0₂ are subsequently dissolved in a little H₂O₂ (first 15%, then 35% of H₂O₂) with warming, giving a dark-blue, clear solution. This complex solution is injected into a container containing 0.5 g of dried inverse SiO₂ powder in a static vacuum. The suspension is stirred for 8 h, then filtered, and the filter cake is dried at 120° C. in a drying cabinet. The filter cake is subsequently calcined at 800° C., giving a white, fine powder which consists of La₂W₃O₁₂:Eu particles embedded in the inverse opal.

### Example 6

### Impregnation of an Aqueous Solution of Molecular Phosphor Precursors (Complexes) into the Pores of the Inverse Opal and Thermal Conversion of the Precursors in the Interior of the Opal into the Phosphor

2.32 mmol of Gd(NO₃)₃ and 0.12 mmol of Eu(NO₃)₃ and 5 mmol of citric acid are dissolved in 10 ml of H₂O. 2.5 mmol of Na₃VO₄ are subsequently dissolved in 5 ml of H₂O with warming, and this solution is added to the solution of the lanthanoids. The pH is then adjusted to 8.4, and this complex solution is injected into a container containing 0.2 g of dried inverse SiO₂ powder in a static vacuum. The suspension is stirred for 8 h, then filtered, and the filter cake is dried at 110° C. in a drying cabinet. The filter cake is subsequently calcined at 600° C., giving a white, fine powder which consists of GdVO₄:Eu particles embedded in the inverse opal.

### Example 7

### Multiple Impregnation of an Aqueous Solution of Molecular Phosphor Precursors into the Pores of the Inverse Opal and Conversion of the Precursors in the Interior of the Opal into the Phosphor

0.095 mol of Y(NO₃)₃6H₂O and 0.005 mol of Eu(NO₃)₃6H₂O and 0.1 mmol of ethylenediamine tetraacetate are dissolved in 70 ml of water, and the pH of the solution is adjusted to 8. The solution is injected into a container containing 0.5 g of dried inverse SiO₂ powder in a static vacuum. The suspenion is stirred for 8 h. The mixture is then filtered, and the filter cake is dried at 110° C. in a drying cabinet. The filter cake is subsequently calcined at 600° C., giving a whitish, fine powder which consists of Y₂O₃:Eu particles embedded in the inverse opal, where the opal is charged with 4% by weight of Y₂O₃:Eu.

This process is then repeated a further three times, with the degree of charging increasing to 15% by weight.

### LIST OF FIGURES

FIG. 1 shows an SEM photograph of the photonic cavity structure (opal structure) of SiO₂. The regular arrangement consisting of the cavities (hollow volumes having a typical diameter of 275 nm) is clearly evident. The cavities are linked to one another by relatively small linking channels, giving rise to the possibility of filling, for example, via the liquid phase (see Example 1).

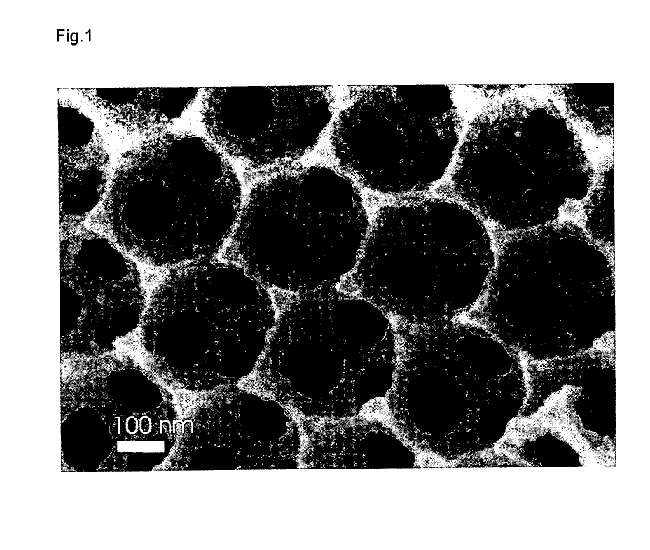

1. Process for the preparation of a photonic material having regularly arranged cavities containing at least one colorant, characterised in that
a) opal template spheres are regularly arranged,
b) the sphere interspaces are filled with one or more wall material precursors,
c) the wall material is formed, and the opal template spheres are removed,
d) the colorant is introduced into the cavities, where dissolved colorant precursors are introduced into the cavities of the inverse opal by means of solution impregnation utilising pore diffusion,
e) the solvent is removed,
f) the precursors are converted into the colorant in a subsequent step.

2. Process according to claim 1, characterised in that at least one colorant or colorant precursor is introduced into the opal template spheres before step a).

3. Process according to claim 1, characterised in that one or more precursors of colorants and/or nanoparticles and colorants are additionally introduced into the sphere interspaces in addition to the wall material precursors in step b).

4. Process according to claim 1, characterised in that step c) is a calcination, preferably above 200° C., particularly preferably above 400° C.

5. Process according to claim 1, characterised in that step f) is a calcination, preferably above 200° C., particularly preferably above 400° C., where a reactive gas may additionally be added.

6. Process according to claim 1, characterised in that step e) is carried out under reduced pressure and/or at elevated temperature.

7. Process according to claim 1, characterised in that the wall of the photonic material essentially consists of an oxide or mixed oxide of silicon, titanium, zirconium and/or aluminium, preferably of silicon dioxide.

8. Process according to claim 1, characterised in that the cavities of the photonic material have a diameter in the range from 100 to 600 nm.

9. Process according to claim 1, characterised in that the cavities of the photonic material are filled to the extent of at least 1% by vol. and at most 50% by vol. with at least one colorant, where the cavities are preferably filled to the extent of at least 5% by vol. and at most 30% by vol. with at least one colorant.

10. Process according to claim 1, characterised in that the at least one colorant makes up 5 to 75% by weight of the photonic material, where the at least one colorant preferably makes up 25 to 66% by weight of the photonic material.

11. Process according to claim 1, characterised in that the photonic material employed is a colorant consisting of an emitter for radiation in the range 550 to 700 nm, which is a rare-earth compound doped with europium, samarium, terbium or praseodymium.

12. Process according to claim 1, characterised in that the colorant employed is at least one compound M^{I}₂O₃:M^{II}, where M^{I}=Y, Sc, La, Gd, Lu and M^{II}=Eu, Pr, Ce, Nd, Tb, Dy, Ho, Er, Tm, Yb, or at least one compound M^{I}₂O₂S:M^{II} or at least one compound M^{III}S:M^{IV},A,X, where M^{III}=Mg, Ca, Sr, Ba, Zn and M^{IV}=Eu, Pr, Ce, Mn, Nd, Tb, Dy, Ho, Er, Tm, Yb and A=Li, Na, K, Rb and X=F, Cl, Br, I, or at least one compound M^{III}M_{V}₂S₄:M^{II}, where M^{V}=Al, Ga, In, Y, Sc, La, Gd, Lu.

13. Process according to claim 1, characterised in that the colorant employed is at least one compound Ln₂O₃:Eu, where Ln=Lu, Gd, Y, or at least one compound Ln (P, V) O₄:Eu, where Ln=Lu, Gd, Y, or at least one compound MeMoO₄:Eu, Na, where Me=Ba, Sr, Ca, or at least one compound MeWO₄:Eu, where Me=Ba, Sr, Ca.

14. Process according to claim 11, characterised in that the rare-earth compound employed is a compound selected from the group of the phosphates, halophosphates, arsenates, sulfates, borates, silicates, aluminates, gallates, germanates, oxides, vanadates, niobates, tantalates, tungstates, molybdates, alkali metal halogenates, halides, nitrides, nitridosilicates, oxynitridosilicates, sulfides, selenides, sulfoselenides and oxysulfides.

15. Illuminant containing at least one light source, characterised in that it comprises at least one photonic material prepared by a process according to claim 1.

16. Illuminant according to claim 15, characterised in that the light source is an indium aluminium gallium nitride, in particular of the formula InᵢGaⱼAlₖN, where 0≦i, 0≦j, 0≦k, and i+j+k=1.

17. Illuminant according to claim 15, characterised in that the light source is a compound based on ZnO.

18. Illuminant according to claim 15, characterised in that the illuminant is a light-emitting diode (LED), an organic light-emitting diode (OLED), a polymeric light-emitting diode (PLED) or a fluorescent lamp.
